(19) United States
(12) Patent Application Publication
(10) Pub. No.: US 2025/0123444 A1
(43) Pub. Date: Apr. 17, 2025

(54) DISPERSION ENGINEERED EVANESCENT MEMS OPTICAL MODULATORS

(71) Applicant: Obsidian Sensors, Inc., San Diego, CA (US)

(72) Inventors: Karl JOHNSON, San Diego, CA (US); John HONG, San Diego, CA (US); Bing WEN, San Diego, CA (US); Sean ANDREWS, San Diego, CA (US); Heesun SHIN, San Diego, CA (US); Edward CHAN, San Diego, CA (US); Tallis CHANG, San Diego, CA (US)

(21) Appl. No.: 18/915,202

(22) Filed: Oct. 14, 2024

Related U.S. Application Data
(60) Provisional application No. 63/543,851, filed on Oct. 12, 2023.

(51) Int. Cl. G02B 6/35

(52) U.S. Cl. CPC G02B 6/3536; G02B 6/3546; G02B 6/3584; G02B 6/3594; G02B 6/3596

(57) ABSTRACT

An integrated MEMS waveguide modulator, including: a static, non-suspended waveguide to guide light traveling through the waveguide; and a dielectric slab movable into and out of an evanescent field surrounding the waveguide using an actuation mechanism, wherein the dielectric slab is movable between a first position that is farthest away possible for the slab from the waveguide and a second position that is closest possible for the slab from the waveguide, wherein dispersion characteristic of the light is controlled by moving the dielectric slab from an unactuated mode that is at the first position to an actuated mode that is at the second position, and wherein the dielectric slab is layered to include non-uniform refractive index profile.

### CROSS-REFERENCE TO RELATED APPLICATIONS

This application claims the benefit of priority under 35 U.S.C. § 119 (e) of co-pending U.S. Provisional Patent Application No. 63/543,851, filed Oct. 12, 2023, entitled “Dispersion Engineered Evanescent MEMS Optical Modulators.” The disclosure of the above-referenced application is incorporated herein by reference.

### BACKGROUND

### Field

The present disclosure relates to optical modulators, and more specifically to dispersion engineered evanescent micro electrical mechanical system (MEMS) optical modulators.

### Background

In the field of integrated photonics, there is a lack of versatile broadband modulators that are compact and relatively high-speed. Thermo-optic, electro-optic, electro-absorption, and carrier enhancement/depletion index modulation all represent mature technologies for modulation of integrated photonic devices. However, none of these options offer the broadband, low loss, low power performance needed for the next generation of reconfigurable photonic circuits in sensing and quantum applications.

To address these issues many researchers have investigated the use of micro electrical mechanical system (MEMS) in integrated photonics, which has enabled several devices such as switches and modulators with extremely high performance. However, photonic MEMS has not yet been adopted in any major capacity, likely owing to the complex fabrication techniques and general incompatibility of existing photonic MEMS with mature integrated photonic design principles.

### SUMMARY

The present disclosure provides for MEMS waveguide modulators.

In one implementation, a MEMS waveguide modulator is disclosed. The modulator includes: a static, non-suspended waveguide to guide light traveling through the waveguide; and a dielectric slab movable into and out of an evanescent field surrounding the waveguide using an actuation mechanism, wherein the dielectric slab is movable between a first position that is farthest away possible for the slab from the waveguide and a second position that is closest possible for the slab from the waveguide, wherein dispersion characteristic of the light is controlled by moving the dielectric slab from an unactuated mode that is at the first position to an actuated mode that is at the second position, and the dielectric slab is layered to include non-uniform refractive index profile.

In another implementation, coupled waveguides are disclosed. Each of the coupled waveguides includes: a static, non-suspended waveguide to guide light traveling through the waveguide; and a dielectric slab movable into and out of an evanescent field surrounding the waveguide using an actuation mechanism, wherein the dielectric slab movable between a first position that is farthest away possible for the slab from the waveguide and a second position that is closest possible for the slab from the waveguide, wherein dispersion characteristic of the light is controlled by moving the dielectric slab from an unactuated mode that is at the first position to an actuated mode that is at the second position.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1A is an example diagram of an integrated MEMS waveguide modulator illustrating the first principle in accordance with one implementation of the present disclosure;

FIG. 1B is an example graph of the effective index versus the waveguide distance;

FIG. 2 is one example plot of the group index as a function of distance as a MEMS structure is moved from a far distance (i.e., outside of the evanescent field for all wavelengths) into the proximity of a waveguide;

FIG. 3 shows the group index curve for a silicon oxide as the MEMS slab is moved towards a 400×1000 nm silicon nitride waveguide;

FIG. 4 shows a plot of the result using one effective strategy in which the waveguide thickness is decreased to reduce the confinement in a vertical direction;

FIG. 5A is a diagram of an integrated MEMS waveguide modulator implemented using another effective strategy in accordance with one implementation of the present disclosure;

FIG. 5B shows that layers with thicker and/or higher index configured on the side closest to the waveguide yield stronger modulation and shift the two points of interest to larger gaps;

FIG. 6A is a top view of an optical modulator showing a dielectric slab, a waveguide, electrodes, and spacers;

FIG. 6B is a side view of the optical modulator showing a curved dielectric slab, the waveguide, the spacers, and the substrate;

FIG. 6C is a side view of the optical modulator showing another curved dielectric slab, the waveguide, the spacers, and the substrate;

FIG. 6D is a side view of the optical modulator showing yet another dielectric slab, the waveguide, the spacers, and the substrate;

FIG. 7 is a graph showing the combinations of lengths and gaps which meet both phase specifications across the desired bandwidth;

FIG. 8A is a top view of the modulator with an H-shaped dielectric slab;

FIG. 8B is a side view of the modulator with an H-shaped dielectric slab that is curved and spacers positioned on top of a waveguide;

FIG. 8C is a side view of the modulator with an H-shaped dielectric slab that is flat and spacers positioned on top of a waveguide;

FIGS. 9A and 9B show an effective index plot and a group index plot, respectively, for a 400×1000 nm silicon nitride waveguide immersed in an oil in accordance with one implementation of the present disclosure;

FIG. 10 shows one example of this combination, wherein the horizontal axis is wavelength in μm, vertical axis is effective index;

FIG. 11A shows an interferometric switch which acts a waveguide moving in and out of the page;

FIG. 11B shows a switch coupler; and

FIGS. 12A and 12B show the unmodulated and modulated, respectively, for one example of a coupled waveguide geometry.

### DETAILED DESCRIPTION

As described above, there is a lack of versatile broadband modulators that are compact and relatively high-speed. That is, none of the currently available technologies for modulation of integrated photonic devices offer the broadband, low loss, low power performance needed for the next generation of reconfigurable photonic circuits in sensing and quantum applications.

Certain implementations of the present disclosure provide for broadband modulators with dispersion engineering capabilities enabled by evanescent modulation of waveguide structures. After reading below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

In one implementation, an integrated MEMS waveguide modulator which moves a dielectric slab in and out of evanescent field of a waveguide mode is disclosed. Two principles for the waveguide modulator may be implemented and may include: anomalous dispersion in modulation of waveguide evanescent fields; and dispersion engineered modulation of evanescent fields in coupled waveguide structures. Using the two principles in the waveguide modulator may enable higher bandwidth, more performant, and simpler to fabricate MEMS modulators and switches.

The integrated MEMS waveguide modulator implemented as stated above may be capable of providing following specifications:
(1) Device footprints in the 10³-10⁴ μm² range;
(2) Switching speed in the high kHz to low MHz range;
(3) Compatibility with wavelengths limited only by the transparency window of the material platform used, for example, 0.4-8 μm for silicon oxide and silicon nitride;
(4) Greater than 0.05 refractive index unit (RIU) modulation of waveguide group index between the unactuated and the actuated states;
(5) Phase modulators (having Lpi<30 μm and Vpi*L<0.1 V*cm) with a phase uniformity of ˜5% over a 10-20% bandwidth, where Lpi is the physical interaction length of the modulator (in the region where the modulator part interacts with the waveguide and influences the propagating mode) required to achieve a pi phase modulation (meaning that it imparts a pi phase shift), and Vpi*L is a common figure of merit which is the product of the voltage and the interaction length required to achieve a pi phase modulation; and
(6) 2×2 switches with <1 dB loss and 20 dB or better isolation over a 10-20% bandwidth.

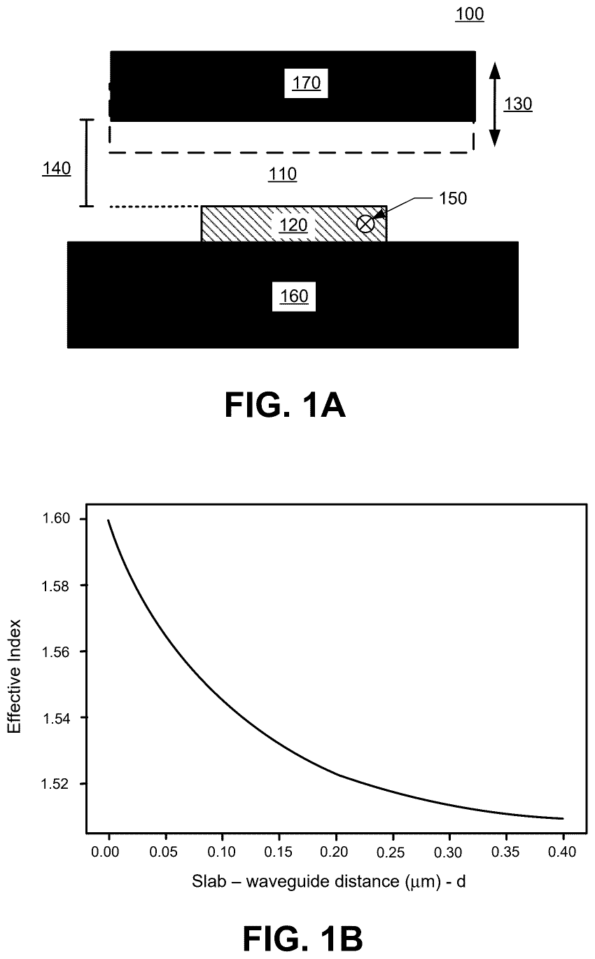

FIG. 1A is an example diagram of an integrated MEMS waveguide modulator 100 illustrating the first principle stated above (i.e., anomalous dispersion in modulation of waveguide evanescent fields) in accordance with one implementation of the present disclosure. In one implementation, FIG. 1A shows a waveguide 120 coupled to a substrate 160. In one implementation, the waveguide 120 guides light in the direction 150 (into the page) as shown. In one implementation, the substrate 160 is implemented with low index material such as silicon dioxide (SiO₂ or glass), while the waveguide 120 is implemented with higher index material. In one implementation, FIG. 1A also shows a dielectric slab 170 situated above the waveguide 120 by a distance 140. In this implementation, there is a medium (or a field) 110 between the dielectric slab 170 and the waveguide 120.

A property of waveguide modes indicates that perturbation of the refractive index in the evanescent field of the mode perturbs an effective index of the mode. Thus, as shown in FIG. 1A, for example, moving (as shown in 130) the dielectric slab 170 into the medium 110 (e.g., air or vacuum) surrounding the waveguide 120 operates it as an optical modulator. Further, if a slab (e.g., the dielectric slab 170) has a refractive index higher than a medium (e.g., the medium 110) through which it is moving, moving the slab closer to a waveguide (e.g., the waveguide 120) increases the effective index of the waveguide mode. FIG. 1B is an example graph of the effective index versus the waveguide distance 140.

As longer wavelengths have a larger mode width than shorter wavelengths for the same waveguide geometry, there are distances at which the waveguide mode of longer wavelengths is modulated more than the mode of shorter wavelengths. In the case of positive effective index modulation, this can cause a negative group index modulation, as the derivative term in Eq. [1] is negative.

$${n}_{g} = {n}_{eff} ( ω ) + ω \frac{\partial {n}_{eff}}{\partial ω} \qquad [ 1 ]$$

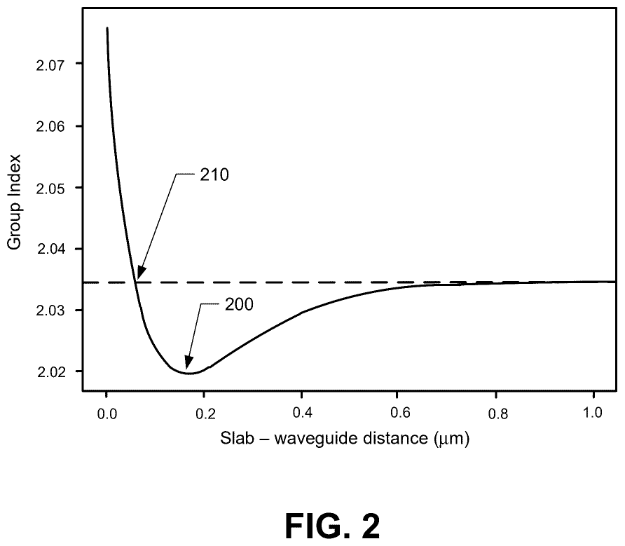

FIG. 2 is one example plot of the group index as a function of distance as a MEMS structure is moved from a far distance (i.e., outside of the evanescent field for all wavelengths) into the proximity of a waveguide.

This group index curve has two notable points: the local extremum at 200 and the zero crossing (zero group index modulation) at 210. It should be noted that the zero-modulation line shown in this plot assumes that the unmodulated (“OFF”) state has the MEMS slab at a far distance (such that the MEMS slab is not interacting at all with the evanescent field). This convention is used throughout the present disclosure, as the design problem for the modulator is simplest when the only critical distance of the actuator is in the ON state. However, the OFF state could in principle be assigned to any finite distance of the actuator, which may open many more degrees of freedom to engineer the performance of the modulator, at the cost of slightly more complexity in the implementation.

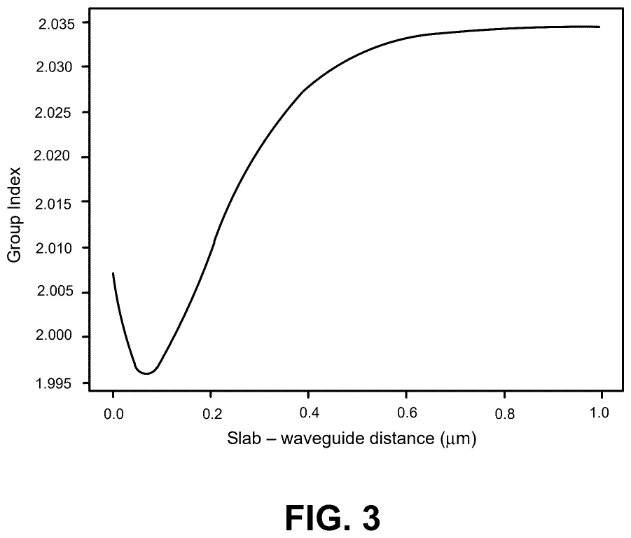

Regarding controlling dispersions, it should be noted that the above plot shown in FIG. 2 is not representative of all MEMS evanescent modulators, and the waveguide and slab may be configured to ensure the dispersion characteristics (of which the group index curve is one measure) are appropriate for a given application. For example, FIG. 3 shows the group index curve for a silicon oxide as the MEMS slab is moved towards a 400×1000 nm silicon nitride waveguide.

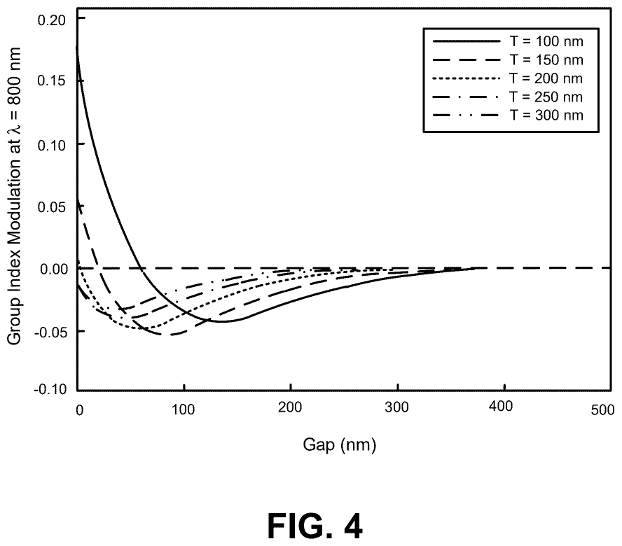

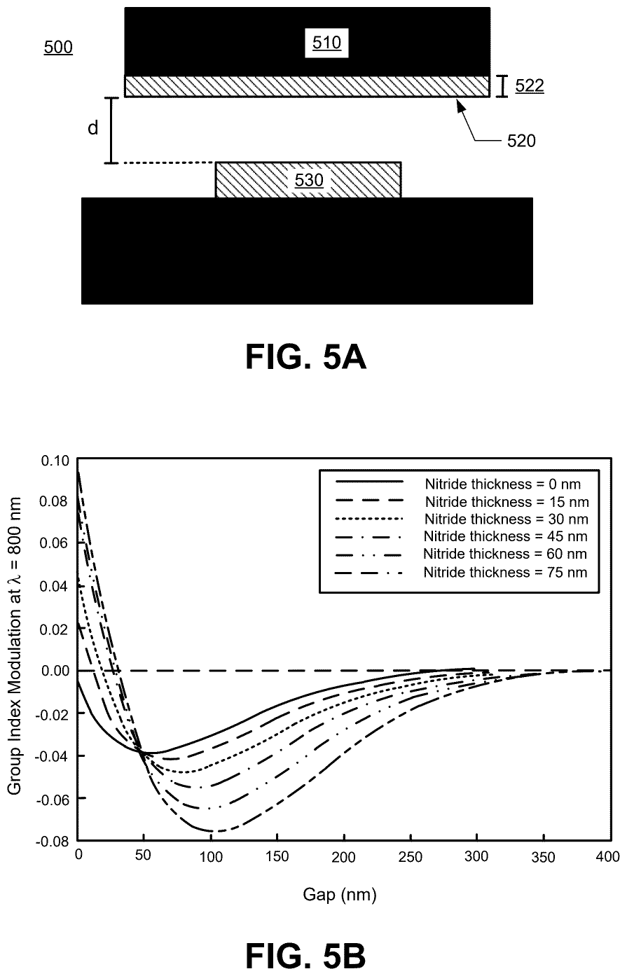

In some implementations (e.g., in the implementation of FIG. 3), modulation of the evanescent field with silicon dioxide (SiO₂) or another low-index dielectric alone may not produce desirable dispersion characteristics, with the local extremum occurring at MEMS gaps very close to zero, and no zero-crossing present at all. Thus, in one implementation, two effective strategies (a result of one is shown in FIG. 4 and another is shown in FIGS. 5A and 5B) may be applied to “shift” the group index curve to the right (i.e., larger gaps) such that the zero-crossing exists and both points occur at desirable gaps.

FIG. 4 shows a plot of the result using one effective strategy in which the waveguide thickness is decreased to reduce the confinement of the waveguide mode in a vertical direction, where reducing the confinement means that the mode shape (transverse distribution of propagating wave energy) expands or widens. Thus, this can increase or decrease the modulation achievable at the extremum, but always moves the points of interest to larger gaps.

FIG. 5A is a diagram of an integrated MEMS waveguide modulator 500 implemented using another effective strategy in accordance with one implementation of the present disclosure. This implementation includes a high index or graded higher index layer 520 (i.e., a layer with a constant or spatially-varying refractive index higher than that of the MEMS slab 510) is introduced in or on the MEMS slab 510.

In one implementation, configuring the layers 510, 520 with thicker and/or higher index on the side closest to the waveguide 530 yield stronger modulation and shift the two points of interest to larger gaps as shown in a plot in FIG. 5B. The thickness of the nitride 522 (specified in FIG. 5B) is shown in FIG. 5A.

In some implementations, other strategies may be used to fine tune the dispersion characteristics. For example, waveguide width, material, shape, and other related parameters such as the slab width, thickness, and shape may be used to finetune the dispersion characteristics. Further, although the description is primarily focused on the behavior of a thin and wide slab moved vertically above a waveguide, the principles of the dispersion engineering also apply to other cases including but not limited to horizontal translation of the MEMS slab, rotation of the MEMS slab, and movement of the MEMS slab into the region other than the waveguide.

One negative effect of modulating the evanescent field using the above-described implementations is the potential for loss to be introduced due to reflection and/or modal mismatch as the field propagates from an unmodulated region (where the MEMS slab (e.g., 170 in FIG. 1) is farthest away from the waveguide (e.g., 120 in FIG. 1)) to a modulated region (where the MEMS slab is closer to the waveguide than in the unmodulated region). While reflective loss is generally quite small, the modal mismatch can be >0.5 dB per transition if not accounted for. Thus, all of the decisions to implement the desired dispersion characteristics must be balanced with the impact that alterations to these parameters have on the loss of the system. In the following descriptions, some examples of how the physical principles detailed above may be implemented are presented.

Regarding group delay modulator implementation, it is noted that the modulation of the group delay is useful for any application in which an optical path length change is desired. Examples include but are not limited to tunable delay lines, reconfigurable optical filters, integrated Fourier transform spectrometers, and pulse shaping.

An important outcome of the dispersion implementation described above is that while the greatest effective index modulation occurs when the gap between the dielectric slab and the waveguide is zero, the group index modulation is generally not maximized there, and instead generally occurs at the local extremum. The local extremum has two desirable traits for group delay modulation: not only is the magnitude of the group index modulation locally maximized (yielding strong modulation), but there is also no first-order sensitivity of the modulation to the gap (yielding robust modulation in the case of digital modulators). Once a combination of waveguide and MEMS geometry parameters has been chosen, the digital MEMS device can be designed such that the dielectric slab is repeatedly moved between the distant OFF slab separation to the ON location at the local extremum.

Analog modulators may be achieved by varying either the index modulation or the modulation length. The index modulation can in principle be controlled simply by controlling the slab separation in an analog manner between the ON and the OFF states. Continuing to actuate past the ON gap yields redundant group index values (but new, higher effective index values). However, if large group delay modulations are desired, the controllability of this separation over the long MEMS structure may be difficult. Further, the close-in effect of electrostatic modulators may lead to some gaps being unstable, making digital modulators which stop at the ON state using physical stops more desirable.

Modulators may be used to create a controllable delay line by segmenting the modulator into multiple, independently controllable lengths. If analog modulation with a large dynamic range is required, it can be achieved through successive analog modulation of each segment. If the application needs only a discrete set of modulations, digital modulators with physical stops may be used alongside a power-of-two configuration for the segment lengths. If fabricated digital modulators do not have the desired magnitude of modulation in the ON state, the ON modulation may be trimmed by adjusting the force placed on the modulator against the hard stops in the ON state (e.g. using the ON voltage for electrostatic actuators). Depending on the mechanical implementation of the hard stops and surrounding MEMS structure, higher forces may be used to fine-tune the slab separation and thus the group index modulation.

The segmented modulator has many advantages, but a substantial disadvantage is the large number of modulated/unmodulated waveguide transitions, as each such transition induces a non-negligible “facet loss” due to reflection and modal mismatch. Additionally, the realization of any single segment with substantial length is made challenging due to the stress-induced curvature inherent in any sufficiently large multi-material structure.

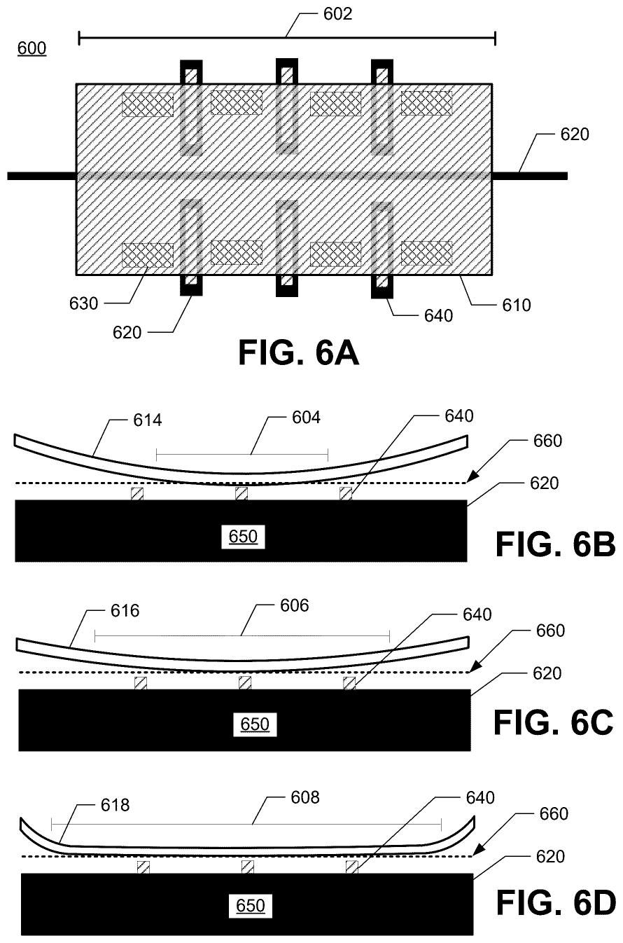

One solution which solves both issues is to modulate the path length not by segmenting the modulator into discrete pieces, but to modulate the curvature of the slab in the propagation direction of the waveguide with multiple independently controllable electrodes, as shown in FIGS. 6A through 6D.

FIG. 6A is a top view of an optical modulator 600 showing a dielectric slab 610, a waveguide 620, electrodes 630, and spacers 640. FIG. 6A also shows the maximum modulation length 602.

FIG. 6B is a side view of the optical modulator 600 showing the dielectric slab 614, the waveguide 620, the spacers 640, and the substrate 650. FIG. 6B also shows the effective modulation length 604 different from the maximum modulation length 602 due to the curvature of the dielectric slab 614.

FIG. 6C is another side view of the optical modulator 600 showing the dielectric slab 616, the waveguide 620, the spacers 640, and the substrate 650. FIG. 6C shows the effective modulation length 606 that is longer than the effective modulation length 604 due to less curvature of the dielectric slab 616.

FIG. 6D is yet another side view of the optical modulator 600 showing the dielectric slab 618, the waveguide 620, the spacers 640, and the substrate 650. FIG. 6D shows the effective modulation length 608 that is even longer than the effective modulation length 606 because the slab 618 for this implementation has curvature only at the ends of the dielectric slab 618.

The architecture of the optical modulator shown in FIGS. 6A through 6D not only effectively utilizes the natural curvature of the slab, but also substantially reduces (or eliminates) all facet loss from the modulator. The long gradual curves of the MEMS slab at either end of the modulator act as an adiabatic taper to gradually transition the unmodulated mode into the modulated mode while avoiding coupling into radiative modes.

In one implementation concerning the broadband phase delay modulator, although group delay (group index) modulation is useful, many important photonic devices instead rely on phase delay (effective index) modulation. One example is interferometric switches, in which the phase difference light interfering from two separate arms yields a particular state at the output. Thus, broadband interferometric switches require a broadband, uniform phase shift, which may be required dispersion engineering. Accordingly, as uniform change of the modulation length or effective index of a modulator may impact the phase change of shorter wavelengths more than that of longer wavelengths, due to the wavelength term for the expression in phase delay, as shown in Equation [2],

$$ϕ = l β = 2 π {n}_{eff} \frac{l}{λ} . \qquad [ 2 ]$$

As the group index is directly proportional to ∂β/∂ω, the zero-crossing point in the group index curve of the MEMS modulator corresponds to the point where

$$\frac{\partial ϕ}{\partial ω} = l \frac{\partial β}{\partial ω} = 0 . \qquad [ 3 ]$$

That is, this is the point where the phase delay is flat with wavelength (around the wavelength at which the group index is being calculated). This is the condition that is required for uniform, broadband phase shifting, and therefore broadband interferometric switching.

Unfortunately, unlike the local extremum, the zero-crossing point is very sensitive to the gap in the ON actuation state, requiring the use of a physical stop and careful mechanical design to allow trimming using the actuation force. Therefore, it should be noted that group index curves alone cannot be used to determine the best gap to use in the ON actuation state for broadband uniform phase modulation, as the group index is necessarily a wavelength-dependent quantity that is different for all the wavelengths in the bandwidth of interest. Accordingly, in one implementation, the group index at the center wavelength of the bandwidth of interest is used for initial estimates, and a broadband analysis of the effective index modulation is used for the final design.

One such method to visualize the broadband performance of the modulator is described herein. In one implementation, initially, a tolerance is chosen for the desired phase modulation across the bandwidth. For example, if a 2×2 interferometric switch with −20 dB isolation in the ON state is desired, the phase modulation across the bandwidth in the ON state must lay in the range [0.95π, 1.05π]. Thus, in this implementation, the combinations of modulation lengths and modulation gaps which meet this specification across the bandwidth (for a fixed waveguide and slab geometry) need to be determined.

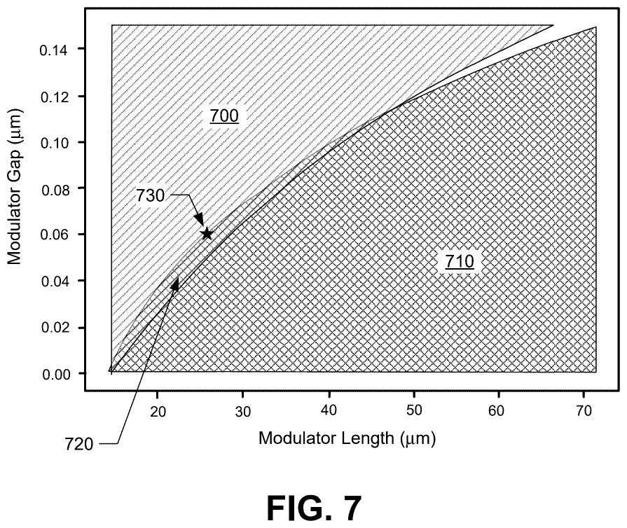

FIG. 7 is a graph showing the combinations of lengths and gaps which meet both phase specifications across the desired bandwidth. In the graph of FIG. 7, region of overlap 720 between region 700 and region 710 in represents the set of design parameters which stay within both the upper region 700 and lower region 710 bounds of the desired phase modulation range. If the region 700 and region 710 do not overlap, there is no configuration of the modulator satisfying the broadband phase modulation requirement and either the bandwidth, phase tolerance, or modulator design must be modified.

The plots shown in FIG. 7 yield multiple conclusions about the performance of the modulator. For one, the group index cancellation point for the center wavelength of the bandwidth (i.e., point 730) is in fact reflective of the general location of the overlap region, but that single point does not indicate any additional information regarding the tolerance of the length and gap. Another useful conclusion is that some amount of tolerance in the length of the MEMS modulator is often acceptable, if the actuation gap of the modulator can be trimmed after fabrication accordingly. It should be noted that due to the large effective index modulation, the actual modulation length is very short for an n phase shift, typically <30 μm (and ˜25 μm in this example). Finally, depending on the device, the tolerance for the actuation gap to meet the phase modulation specification may be extremely small, usually <+/−10 nm (and <+/−5 nm here).

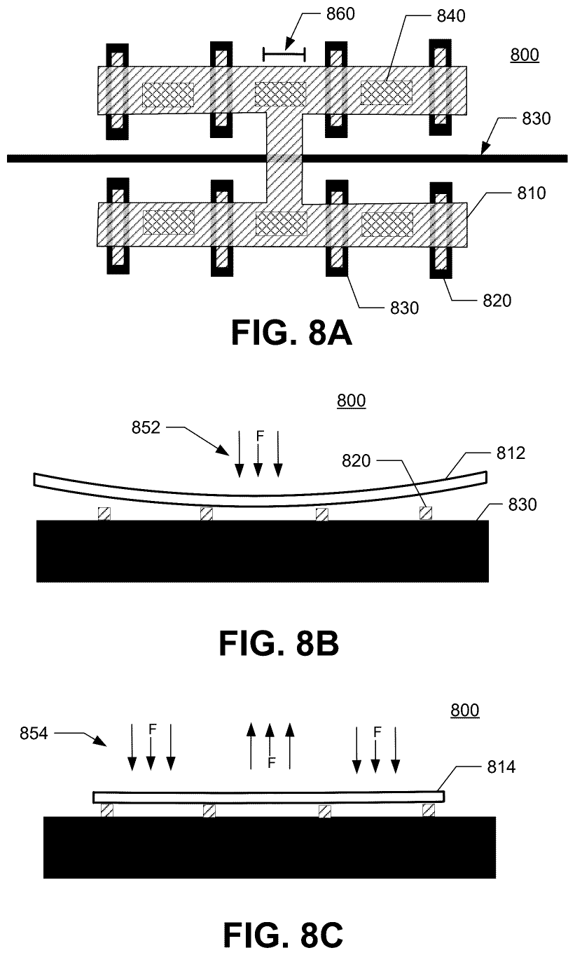

The requirements imposed by this analysis require a MEMS modulator with a short modulation length and extremely fine control of the gap post-fabrication. One such implementation of a modulator 800 is shown in FIGS. 8A though 8C.

FIG. 8A is a top view of the modulator 800 with an H-shaped dielectric slab 810. Distance 860 is the modulation length.

FIG. 8B is a side view of the modulator 800 with an H-shaped dielectric slab 812 that is curved and spacers 820 positioned on top of a waveguide 830. Force fields 852 are as shown to tune the gap to be smaller than the spacer height.

FIG. 8C is a side view of the modulator 800 with an H-shaped dielectric slab 814 that is flat and spacers 820 positioned on top of a waveguide 830. Force fields 854 are as shown to tune the gap to be smaller than the spacer height.

As shown in FIG. 8A, the modulator 800 employs the H-shaped dielectric slab 810, electrostatic actuation, and uses spacers 820 on the substrate side of the modulator to approximately set the closing gap of the modulator. In one implementation, the spacers 820 are spaced such that adjustment to the slab curvature using multiple electrodes 840 can fine tune the actual gap between the slab 810 and the waveguide 830. Placing the MEMS electrodes 840 on top of the dielectric slab 810 and the high spring constant associated with the strain of the curved slab can prevent close-in instability of the electrostatic actuators and yield the single-digit nm control necessary to achieve the stringent requirements of broadband phase control. This H-shaped modulator is only one example of an implementation for a broadband MEMS phase modulator, and many other designs may be used to achieve the same optical result.

In some implementations, it is advantageous to include both group delay modulators and broadband phase modulators on a same chip (e.g., to include tunable delay lines as well as switches in a reconfigurable photonic circuit). Since the only difference in geometry between a properly engineered group modulator and phase modulator is the closing gap, both modulators can be fabricated on the same chip by adding one additional process step to differentiate the thickness of the physical stop between the two modulator types. Alternatively, if analog control of the group index modulator is feasible without hard stops, no additional process step is required.

In one implementation, regarding immersion MEMS, the fluid surrounding the MEMS structure and waveguide is a liquid with a much higher refractive index. Use of an immersion medium with a refractive index higher than that of the MEMS slab (but lower than that of the waveguide) may behave in a manner inverted from that of the descriptions above. The effective index has usually had a negative modulation which is stronger at longer wavelengths, so the local extremum has a positive group index modulation.

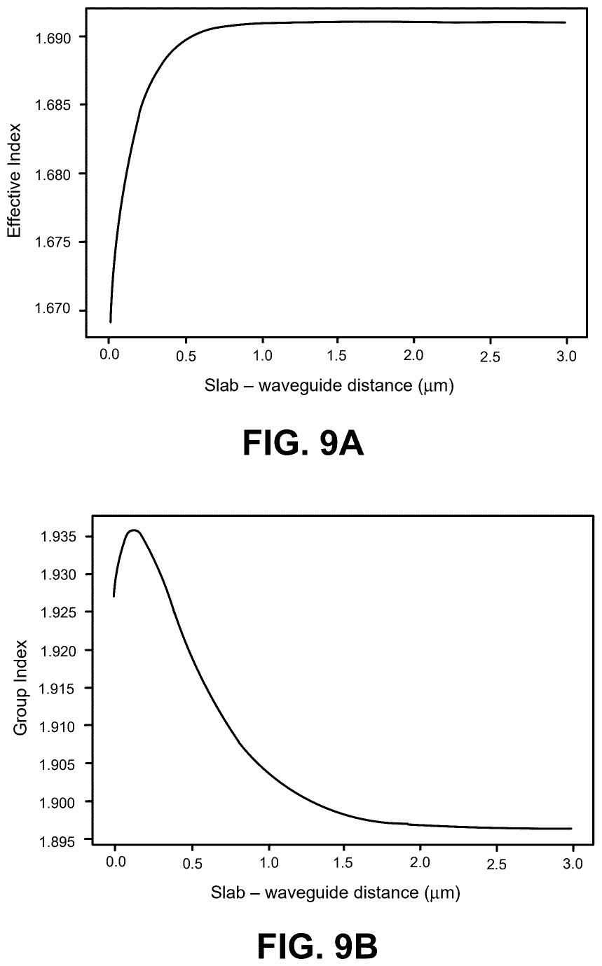

FIGS. 9A and 9B show an effective index plot and a group index plot, respectively, for a 400×1000 nm silicon nitride waveguide immersed in an oil (i.e., n=1.6) at a wavelength of 1550 nm, modulated by an oxide only MEMS slab in accordance with one implementation of the present disclosure.

In the above implementation, the immersion medium also causes the confinement of the waveguide to be substantially lower, and as such the slab-waveguide distances are substantially larger than in the air cladding case. This may be useful for path length modulators at short wavelengths.

By combining materials with a refractive index higher than the immersion index (such as silicon nitride and oxynitrides) with materials having an index lower than the immersion (such as oxides), it is also possible to engineer a near-zero effective index change (at one wavelength) but a nonzero group index change.

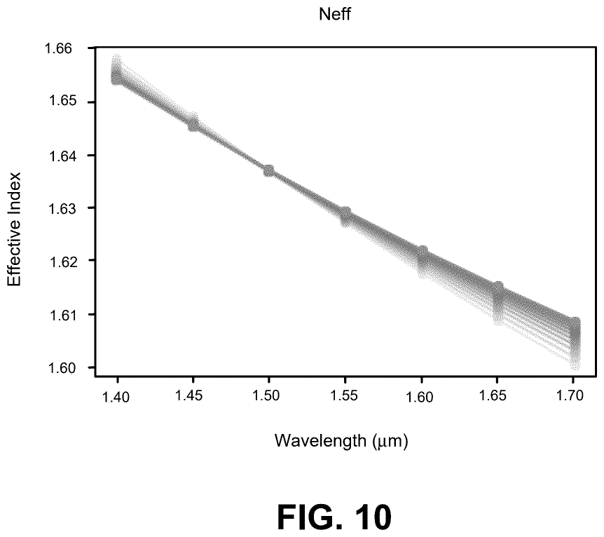

FIG. 10 shows one example of this combination, wherein the horizontal axis is wavelength in μm, vertical axis is effective index. Lines in the graph represent different actuation states.

This indicates that a wide range of unique group/effective index modulations are possible using air or oil immersed evanescent MEMS modulators (Table 1).

| | Δn_{g} > 0 | Δn_{g} = 0 | Δn_{g} < 0 |
|---|---|---|---|
| Δn_{eff} > 0 | MEMS in air, g < | MEMS in air, g = | MEMS in air, g > |
| | zero crossing | zero crossing | zero crossing |
| Δn_{eff} = 0 | MEMS in oil, gap | No modulation | Unknown |
| | invariant, but only | | |
| | at 1 wavelength | | |
| Δn_{eff} < 0 | MEMS in oil, g > | MEMS in oil, g = | MEMS in oil, g < |
| | zero crossing | zero crossing | zero crossing |

The numerous modulation combinations in this table may be useful for dispersion engineering problems, such as shaping of fast laser pulses.

Regarding tilted slabs along the propagation axis, although the impact of the slab tilt on the dispersion characteristics is fairly small, the slab tilt can have an impact on the symmetry of the system, and therefore the polarization characteristics of the mode. Specifically, the normal modes of the structure may no longer be aligned with the transverse electric (TE) and transverse magnetic (TM) modes of an unmodulated rectangular waveguide. This yields a waveplate effect which may be used to make a polarization-based switch.

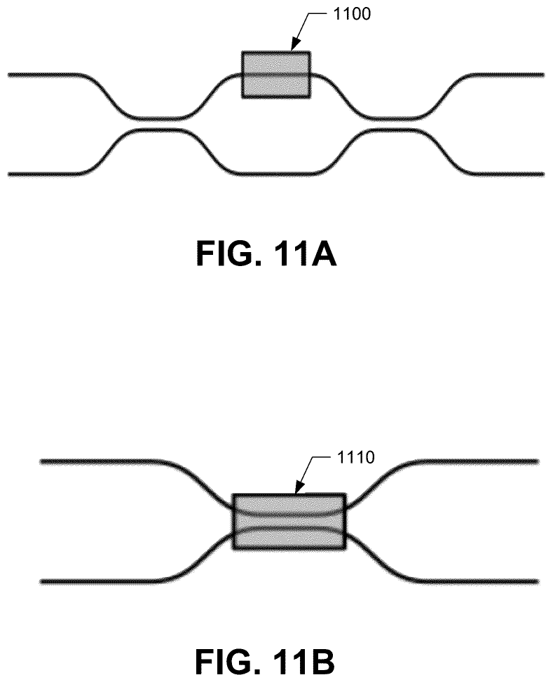

FIGS. 11A and 11B are example diagrams of MEMS switches 1100, 1110, respectively, illustrating the second principle stated above (i.e., dispersion engineered modulation of evanescent fields in coupled waveguide structures) in accordance with one implementation of the present disclosure. FIG. 11A shows an interferometric switch 1100 which acts a waveguide moving in and out of the page, while FIG. 11B shows a switch coupler 1110.

In some implementations, the properties of a coupled waveguide system are modified by a MEMS structure (just as those of a single waveguide may be modified). Instead of considering the effective and group index of the mode in a single waveguide, the impact of the MEMS structure on the coupler is often characterized either by the change in the coupling matrix of the waveguide modes, or by the change in modal profile and effective index difference of the coupler supermodes. The supermodes represent optical fields which propagate unchanged along the coupler despite the presence of gain, loss, asymmetry and nonlinear effects. In one implementation, the above-descriptions of the MEMS structure enable the creation of new types of switches. Although the broadband phase modulators described above enable broadband switches when incorporated into an interferometric switch (known as Mach-Zehnder interferometer (MZI)) with broadband couplers, switches created by modulating a single coupler have a substantial footprint advantage.

In the case of single waveguides, it was shown above that the introduction of a tilted slab causes an asymmetry in the system that impacts the polarization state of the normal modes. When the same tilted slab technique is done in proximity to two coupled waveguides, the effective index of the modes in each waveguide is modulated by different amounts. When the two-waveguide system is modeled using coupled mode equations,

$$\frac{d}{dz} ( \begin{matrix}{A}_{1} \\ {A}_{2}\end{matrix} ) = - j ( \begin{matrix}- δ & κ \\ κ & δ\end{matrix} ) ( \begin{matrix}{A}_{1} \\ {A}_{2}\end{matrix} ) , \qquad [ 4 ]$$

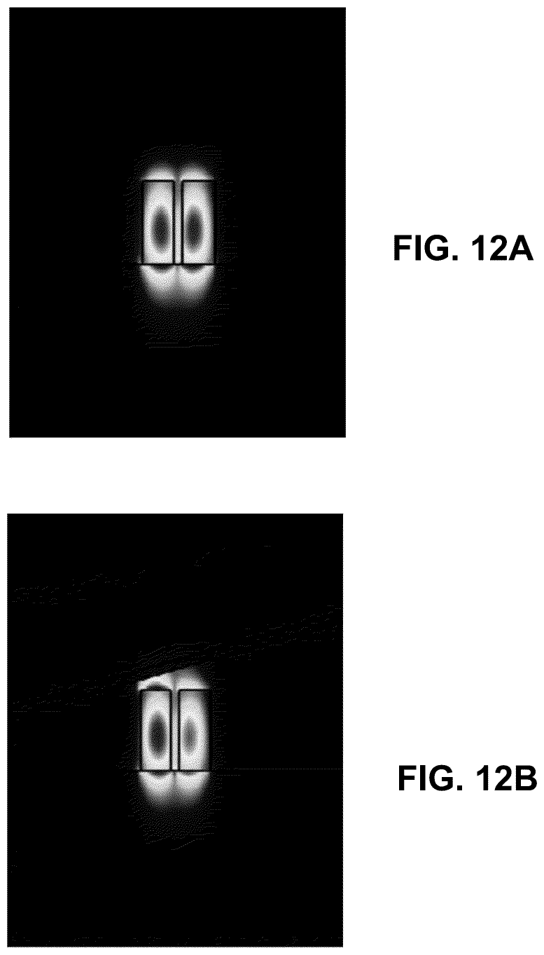

the introduction of a tilted slab primarily modulates the δ terms, with a substantially lesser impact on the k terms. Alternatively, the introduction of the tilted slab may be interpreted as increasing the index difference of the supermodes, as well as modifying the modal overlap of the supermodes with the individual waveguide modes. FIGS. 12A and 12B show the unmodulated and modulated even supermodes, respectively, for one example of a coupled waveguide geometry.

Either interpretation yields the conclusion that the introduction of the tilted slab impacts the Ln of the coupled waveguides. As such, modulation of the coupling region of a directional coupler with a tilted MEMS slab alters the amount of power transmitted from an input port to the “through” and “drop” ports of the coupler. The coupler can then be designed (through choice of the waveguide geometry, spacing, coupler length, and modulator geometry) to have the desired splitting ratios in the ON and OFF states at the wavelength of operation.

Importantly, this switch is based on a directional coupler, which is fundamentally a narrowband device, so the resulting device will only achieve the designed splitting ratios in a narrow bandwidth around the design wavelength. While dispersion engineering techniques may be used to increase the bandwidth in the ON state, the unmodulated OFF state acts as a typical directional coupler and as such is subject to the usual bandwidth constraints.

The limited bandwidth of this approach may be improved by using a push/pull design in which the two switch states correspond to the slab being tilted in two different directions, rather than the slab being tilted or completely retracted. This allows for the unique dispersion characteristics of the actuated slab to be applied in both actuation states, potentially enabling more broadband performance in both actuation states.

Another method to achieve broadband performance of the switch is to modulate a broadband coupler structure instead of a directional coupler structure. Broadband couplers such as adiabatic and shortcut to adiabatic (STA) couplers often rely on mode evolution instead of mode coupling as their mechanism of operation, and the capability of such structures for broadband performance is well-known. As such, in an ON/OFF modulated coupler approach, the OFF state does not suffer the same bandwidth limitations as the switched directional coupler method described above. Dispersion engineering techniques may then be used to improve the bandwidth in the ON state, yielding a broadband switch.

In one particular implementation, a MEMS waveguide modulator is disclosed. The modulator includes: a static, non-suspended waveguide to guide light traveling through the waveguide; and a dielectric slab movable into and out of an evanescent field surrounding the waveguide using an actuation mechanism, wherein the dielectric slab is movable between a first position that is farthest away possible for the slab from the waveguide and a second position that is closest possible for the slab from the waveguide, wherein dispersion characteristic of the light is controlled by moving the dielectric slab from an unactuated mode that is at the first position to an actuated mode that is at the second position, and the dielectric slab is layered to include non-uniform refractive index profile.

In one implementation, the dielectric slab is curved to vary the dispersion characteristic of the light and polarization characteristics of the waveguide modulator. In one implementation, the dielectric slab is a low-index material including silicon oxide and silicon dioxide to (SiO₂) produce the dispersion characteristic of the light that is desirable. In one implementation, the low-index material is layered to include non-uniform refractive index profile. In one implementation, the low-index material is also curved to produce a large effective index modulation but near zero group index modulation. In one implementation, the waveguide modulator with the low-index material is configured as a Mach-Zehnder interferometer (MZI) switch. In one implementation, the MZI switch includes broadband 2×2 3-dB couplers to configure a bypass switch with a large optical bandwidth. In one implementation, a dielectric slab in each of a plurality of modulators are configured as the low-index material, and wherein the plurality of modulators is configured with different lengths to obtain a discretely tunable delay line. In one implementation, the waveguide modulator is configured as a flexible modulator that is actuated along a length of the waveguide to adjust an active length of the waveguide modulator and to yield a continuously tunable, low loss group delay line. In one implementation, the dielectric slab is curved to configure the modulator as a broadband switchable waveplate. In one implementation, the waveguide modulator further includes a plurality of polarization filters to configure the modulator as a polarization based on/off switch. In one implementation, the waveguide modulator is immersed in a high-index medium so that actuating the dielectric slab induces a zero or negative effective index change. In one implementation, the high-index medium is oil.

In another particular implementation, coupled waveguides are disclosed. Each of the coupled waveguides includes: a static, non-suspended waveguide to guide light traveling through the waveguide; and a dielectric slab movable into and out of an evanescent field surrounding the waveguide using an actuation mechanism, wherein the dielectric slab movable between a first position that is farthest away possible for the slab from the waveguide and a second position that is closest possible for the slab from the waveguide, wherein dispersion characteristic of the light is controlled by moving the dielectric slab from an unactuated mode that is at the first position to an actuated mode that is at the second position.

In one implementation, the coupled waveguides are configured as a low-loss, switchable directional coupler to modulate a coupled waveguide region. In one implementation, the coupled waveguides are configured as a low-loss, broadband 2×2 switch to modulate a coupled waveguide region in at least one of (a) a mode evolution and (b) a shortcut to adiabaticity.

The description herein of the disclosed implementations is provided to enable any person skilled in the art to make or use the present disclosure. Numerous modifications to these implementations would be readily apparent to those skilled in the art, and the principals defined herein can be applied to other implementations without departing from the spirit or scope of the present disclosure. Thus, the present disclosure is not intended to be limited to the implementations shown herein but is to be accorded the widest scope consistent with the principal and novel features disclosed herein.

Various implementations of the present disclosure are realized in electronic hardware, computer software, or combinations of these technologies. Some implementations include one or more computer programs executed by one or more computing devices. In general, the computing device includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., game controllers, mice and keyboards), and one or more output devices (e.g., display devices).

The computer programs include executable code that is usually stored in a persistent storage medium and then copied into memory at run-time. At least one processor executes the code by retrieving program instructions from memory in a prescribed order. When executing the program code, the computer receives data from the input and/or storage devices, performs operations on the data, and then delivers the resulting data to the output and/or storage devices.

Those of skill in the art will appreciate that the various illustrative modules and method steps described herein can be implemented as electronic hardware, software, firmware or combinations of the foregoing. To clearly illustrate this interchangeability of hardware and software, various illustrative logics and method steps have been described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the present disclosure. In addition, the grouping of functions within a module or step is for ease of description. Specific functions can be moved from one module or step to another without departing from the present disclosure.

All features of each above-discussed example are not necessarily required in a particular implementation of the present disclosure. Further, it is to be understood that the description and drawings presented herein are representative of the subject matter that is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. An integrated micro electrical mechanical system (MEMS) waveguide modulator, the modulator comprising:
a static, non-suspended waveguide to guide light traveling through the waveguide; and
a dielectric slab movable into and out of an evanescent field surrounding the waveguide using an actuation mechanism,
wherein the dielectric slab is movable between a first position that is farthest away possible for the slab from the waveguide and a second position that is closest possible for the slab from the waveguide,
wherein dispersion characteristic of the light is controlled by moving the dielectric slab from an unactuated mode that is at the first position to an actuated mode that is at the second position, and
wherein the dielectric slab is layered to include non-uniform refractive index profile.

2. The waveguide modulator of claim 1, wherein the dielectric slab is curved to vary the dispersion characteristic of the light and polarization characteristics of the waveguide modulator.

3. The waveguide modulator of claim 1, wherein the dielectric slab is a low-index material including silicon oxide and silicon dioxide to (SiO₂) produce the dispersion characteristic of the light that is desirable.

4. The waveguide modulator of claim 3, wherein the low-index material is layered to include non-uniform refractive index profile.

5. The waveguide modulator of claim 4, wherein the low-index material is also curved to produce a large effective index modulation but near zero group index modulation.

6. The waveguide modulator of claim 5, wherein the waveguide modulator with the low-index material is configured as a Mach-Zehnder interferometer (MZI) switch.

7. The waveguide modulator of claim 6, wherein the MZI switch includes broadband 2×2 3-dB couplers to configure a bypass switch with a large optical bandwidth.

8. The waveguide modulator of claim 5, wherein a dielectric slab in each of a plurality of modulators are configured as the low-index material, and
wherein the plurality of modulators is configured with different lengths to obtain a discretely tunable delay line.

9. The waveguide modulator of claim 1, wherein the waveguide modulator is configured as a flexible modulator that is actuated along a length of the waveguide to adjust an active length of the waveguide modulator and to yield a continuously tunable, low loss group delay line.

10. The waveguide modulator of claim 1, wherein the dielectric slab is curved to configure the modulator as a broadband switchable waveplate.

11. The waveguide modulator of claim 10, further comprising a plurality of polarization filters to configure the modulator as a polarization based on/off switch.

12. The waveguide modulator of claim 1, wherein the waveguide modulator is immersed in a high-index medium so that actuating the dielectric slab induces a zero or negative effective index change.

13. The waveguide modulator of claim 12, wherein the high-index medium is oil.

14. A coupled waveguides, each of the coupled waveguides comprising:
a static, non-suspended waveguide to guide light traveling through the waveguide; and
a dielectric slab movable into and out of an evanescent field surrounding the waveguide using an actuation mechanism,
wherein the dielectric slab movable between a first position that is farthest away possible for the slab from the waveguide and a second position that is closest possible for the slab from the waveguide,
wherein dispersion characteristic of the light is controlled by moving the dielectric slab from an unactuated mode that is at the first position to an actuated mode that is at the second position.

15. The coupled waveguides of claim 14, wherein the coupled waveguides are configured as a low-loss, switchable directional coupler to modulate a coupled waveguide region.

16. The coupled waveguides of claim 14, wherein the coupled waveguides are configured as a low-loss, broadband 2×2 switch to modulate a coupled waveguide region in at least one of (a) a mode evolution and (b) a shortcut to adiabaticity.
